(19) United States
(12) Patent Application Publication
(10) Pub. No.: US 2026/0186979 A1
(43) Pub. Date: Jul. 2, 2026

(54) ADDRESS TRANSLATION FOR COMBINED NON-VOLATILE MEMORY (NVM) AND DYNAMIC RANDOM ACCESS MEMORY (DRAM) DEVICE

(71) Applicant: Micron Technology, Inc., Boise, ID (US)

(72) Inventors: Suresh Rajgopal, San Diego, CA (US); Sundararajan Sankaranarayanan, Fremont, CA (US); Xiangyu Tang, San Jose, CA (US); Jeffrey S. McNeil, Boise, ID (US); Eric N. Lee, San Jose, CA (US); Akira Goda, Tokyo (JP); William Akin, Morgan Hill, CA (US)

(21) Appl. No.: 19/434,315

(22) Filed: Dec. 29, 2025

Related U.S. Application Data
(60) Provisional application No. 63/740,399, filed on Dec. 31, 2024.

(51) Int. Cl. G06F 12/1045; G06F 12/02

(52) U.S. Cl. CPC G06F 12/1045; G06F 12/0246; G06F 2212/7201

(57) ABSTRACT

An example address translation method includes: receiving, by a controller of a memory device including one or more volatile memory dies and one or more non-volatile memory dies, a memory read request; responsive to determining that a logical memory address specified by the memory read request exceeds an upper limit of a user-addressable capacity of the one or more volatile memory dies, translating the logical memory address to a physical memory address identifying a transfer unit (TU) residing on a non-volatile memory die of one or more non-volatile memory dies; retrieving, from the non-volatile memory die, a data item stored by the TU identified by the physical memory address; storing the data item in a cache located on a volatile memory die of the one or more volatile memory dies; and transmitting the data item to the requestor.

### REFERENCE TO RELATED APPLICATIONS

This application claims the priority benefit of U.S. Provisional Patent Application No. 63/740,399, filed Dec. 31, 2024, the entirety of which is incorporated herein by reference.

### TECHNICAL FIELD

Implementations of the disclosure relate generally to memory devices, and more specifically, relate to address translation for combined non-volatile memory (NVM) and dynamic random access memory (DRAM) devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIGS. 1A-1B show example high-level component diagrams of hybrid NVM/HBM devices implemented in accordance with aspects of the present disclosure.

FIG. 2 schematically illustrates example logical and physical address spaces of the hybrid NVM/HBM devices implemented in accordance with aspects of the present disclosure.

FIG. 3A schematically illustrates the read (look aside) cache flow implemented by the memory controller operating in accordance with aspects of the present disclosure.

FIG. 3B schematically illustrates the read (fully associative) look through cache flow implemented by the memory controller operating in accordance with aspects of the present disclosure.

FIG. 4 schematically illustrates the write-through policy implemented by the memory controller operating in accordance with aspects of the present disclosure.

FIG. 5 is a flow diagram of an example method of address translation performed by a memory controller operating in accordance with some implementations of the present disclosure.

FIG. 6 illustrates an example computing system that includes a memory sub-system implemented in accordance with some implementations of the present disclosure.

FIG. 7 is a block diagram illustrating a system for performing AI model inference operations using memory devices and/or host systems implemented in accordance with aspects of the present disclosure.

FIG. 8 is a block diagram of an example computer system in which implementations of the present disclosure may operate.

### DETAILED DESCRIPTION

Aspects of the present disclosure are directed to a combined non-volatile memory (NVM) and dynamic random access memory (DRAM) device. A memory sub-system can include one or more storage devices, memory modules, and/or hybrid storage devices and memory modules. Examples of storage devices and memory modules are described below. In general, a host system can utilize a memory sub-system that includes one or more components, such as memory devices that store data. The host system can provide data to be stored at the memory sub-system and can request data to be retrieved from the memory sub-system.

A memory sub-system may utilize one or more memory devices, including any combination of the different types of non-volatile memory devices and/or volatile memory devices, to store the data provided by the host system. In some implementations, non-volatile memory devices may be provided by negative-and (NAND) type flash memory devices. A non-volatile memory device is a package of one or more dies. Each die (“logical unbit”) may include one or more planes. For some types of non-volatile memory devices (e.g., NAND devices), each plane may include a set of physical blocks. Each block may in turn include a set of pages. Each page includes a set of memory cells. A memory cell is an electronic circuit that stores one or more bits of information.

A memory device may include multiple memory cells arranged in a two-dimensional grid. The memory cells can be formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In some implementations, memory sub-systems can be used to store data used to train machine learning (ML) and artificial intelligence (AI) frameworks, as well as data on which the ML/AI framework can be executed. An ML/AI framework can include a model, which is a representation of a neural network designed to produce one or more outputs responsive to one or more inputs. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For example, the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing units (e.g., graphics processing units (GPUs) and/or central processing units (CPU)) which can process multiple threads/streams in parallel. During the inference phase, these processing units utilize relatively small chunks of data (e.g., tens or hundreds of bytes) from a significantly larger corpus of data (e.g., many gigabytes or terabytes) stored at a memory sub-system. For example, the inference phase may involve walking through multiple graph nodes in order to determine the value of a vertex element and identify its connections.

In some implementations, the input data can be loaded from the memory sub-system to a local host memory co-located with the processing units executing the ML/AI framework. This host memory can be implemented using high bandwidth memory (HBM) devices that offer extremely high (i.e., fast) performance, but have relatively low storage capacities.

In some implementations, multiple processing units (GPUs and/or CPUs) can be connected to a shared memory pool, such that each processing unit can have its own local memory and can also access, over a high-speed interconnect, the memory that is local to other processing units. However, the local memory accesses would exhibit much lower latency as compared to the remote memory accesses.

Thus, the memory capacity is one of the biggest challenges faced by enterprise deployment of artificial intelligence (AI) models. Various solutions involve increasing the number of dies stacked in HBM packages accessible by a processing unit (e.g., a GPU) and implementing various non-uniform memory access (NUMA) schemes in which a processing unit, in addition to its local memory, may also access a local memory of another processing unit. However, these and other solutions fail to adequately satisfy the growing memory capacity requirements while delivering the requisite memory access bandwidth and latency, not to mention containing the costs.

Aspects of the present disclosure address the above and other deficiencies by integrating non-volatile memory (NVM) with high-bandwidth memory (HBM) within a single device (e.g., an integrated circuit (IC)). In some implementations, the hybrid NVM/HBM device may also include one or more processing units (e.g., GPUs and/or CPUs), thus affording the increased memory capacity to the processing units, thereby reducing the need for remote data movement operations between the memory dies that are locally accessible by the processing units.

In an illustrative example, the hybrid NVM/HBM device may include one or more one NVM dies, one or more HBM dies, and a logic die on which a local memory controller can reside. The local memory controller may perform the address translation and other local memory management tasks.

In another illustrative example, the combined NBM and HBM device may also include one or more compute dies on which one or more processing units (GPUs and/or CPUs) can reside.

In some implementations, one or more hybrid NVM/HBM devices implemented in accordance with one or more aspects of the present disclosure may be packaged into a specified form factor, e.g., a form factor utilized by non-volatile memory devices, a form factor utilized by storage devices (such as solid state drives (SSDs)), etc. Using a standard memory form factor would facilitate seamless integration of the device into various computing systems, such as, e.g., Internet-of-Things (IoT) devices, wearable or portable computing devices, automotive computing devices, enterprise compute systems, or enterprise storage systems.

Advantages of the approach described herein include the improved performance of memory devices and subsystems, which may be particularly beneficial when used in ML/AI frameworks, as described in more detail herein below.

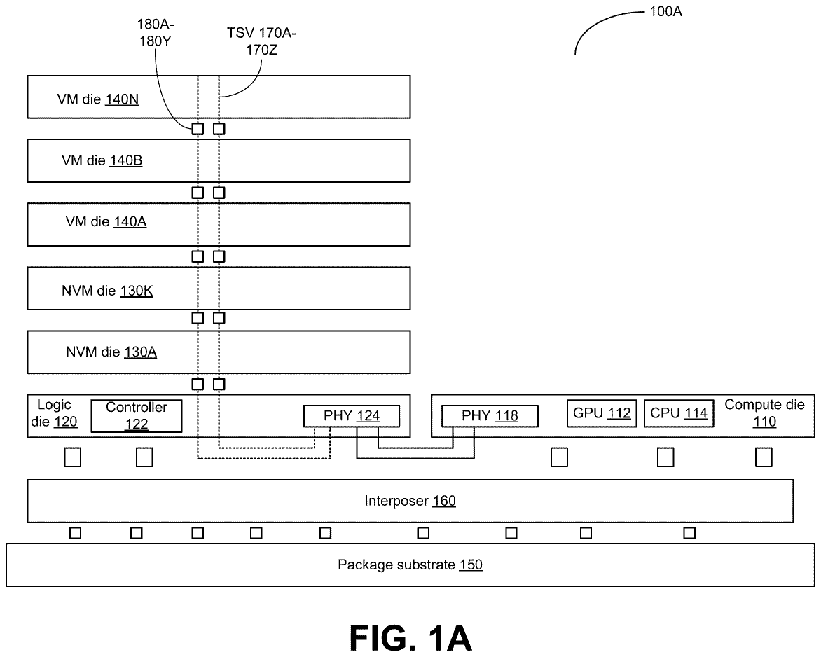

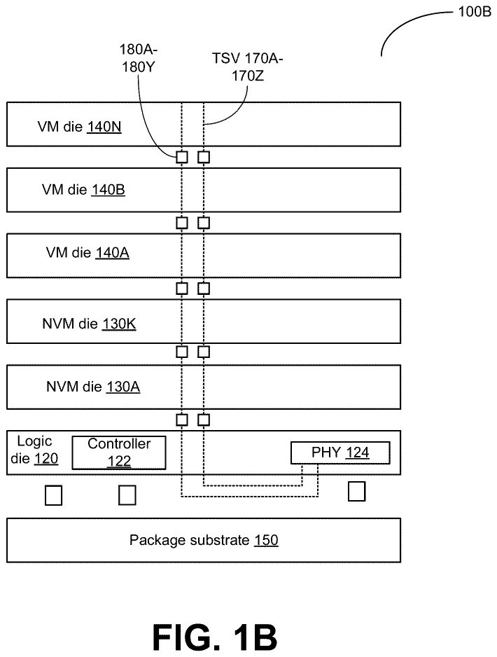

FIG. 1A shows an example high-level component diagram of a hybrid NVM/HBM device implemented in accordance with aspects of the present disclosure. As schematically illustrated by FIG. 1A, the hybrid memory and compute device 100A may be implemented as an integrated circuit (IC) that includes a compute die 110, a logic die 120, one or more NVM dies 130A-130K, and one or more volatile memory (VM) dies 140A-140N, all the dies being disposed on a common package substrate 150.

Disposed on the compute die 110 are one or more processing units (e.g., one or more GPUs 112 and/or one or more CPUs 114) and their respective auxiliary circuitry, including local memory, input/output (I/O) interfaces, etc., which are omitted from FIG. 1A for clarity and conciseness. While a single compute die 110 is shown in FIG. 1A for clarity and conciseness, in various other implementations, device 100A may include two or more compute dies 110.

In some implementations, an NVM die 130 may be represented by a NAND die. In some implementations, one or more NVM dies 130 may be single-level cell (SLC) NAND dies, which exhibit better endurance and lower access latency as compared, e.g., to multiple-level cell (MLC), triple-level cell (TLC), or quad-level cell (QLC) dies.

In some implementations, a VM die 140 may be represented by an HBM dynamic random access memory (DRAM) die.

While a single logic die 120 is shown in FIG. 1A for clarity and conciseness, in various other implementations, device 100A may include two or more logic dies 120.

The stacked VM dies 140, NVM dies 130, and the logic die 120 may be interconnected by through-silicon vias (TSVs) 170A-170Z and microbumps 180A-180Y. A TSV is a high-performance interconnect technique that utilizes a vertical electrical connection (via) that passes through a silicon wafer or die. “Microbumps” are small raised spheres which are made of a conductive material and connect a die with another die or a substrate, thus serving as conduits delivering electrical signals from one part of a chip to another.

The components disposed on the compute die 110 may communicate with the components disposed on the logic die 120, components disposed on the NVM dies 130A-130K, and/or components disposed on the VM dies 140A-140N via respective physical interfaces (PHYs) 118, 124 interconnected by the interposer 160. An interposer is an electrical interface routing electrical signals between one socket or connection and another socket or connection. Thus, the memory access requests issued by the processing units residing on the compute die 110 may be transmitted via the interposer 160 to the logic die 120.

Disposed on the logic die 120 is the controller 122 managing the NVM dies 130 and/or the VM dies 140. In some implementations, the controller 122 may implement a common logical address space for the VM dies 140A-140N and the NVM dies 130A-130K. Accordingly, the controller 122 may perform logical-to-physical (L2P) address translation based on the common logical address space.

In some implementations, no address translation (other than offsetting by a predefined value) may be required for the memory addresses that are below the upper limit of the user-addressable capacity of the VM dies 140A-140N. In other words, the addresses within the user-addressable capacity of the VM dies 140A-140N will directly (e.g., with an optional offset) reference respective memory locations on the VM dies 140A-140N, while the addresses exceeding the upper limit of the user-addressable capacity of the VM dies 140A-140N:

$$if A <= NVM Capacity$$

$$then$$

$${LA}_{VM} = A + Offset$$

$$else$$

$${LA}_{NVM} = L 2 P [ A ]$$

where A is the memory address,
NVM Capacity is he user-addressable capacity of the VM dies 140A-140N,
LA_{VM} is the logical address of a TU residing on the VM dies 140A-140N,
Offset is the optional offset to be applied to the logical addresses,
LA_{NVM} is the logical address of a TU residing on the VM dies 130A-130K,
L2P[ . . . ] is the logical-to-physical (L2P) address translation table, and
L2P[A] is the physical address corresponding to the specified memory address A.

In some implementations, no address translation (other than offsetting by a predefined value) may be required for the logical addresses that are below the upper limit of the user-addressable capacity of the VM dies 140A-140N. In other words, the logical addresses within the user-addressable capacity of the VM dies 140A-140N will directly (e.g., with an optional offset) reference respective memory locations on the VM dies 140A-140N, while the logical addresses exceeding the upper limit of the user-addressable capacity of the VM dies 140A-140N:

$$if LBA <= NVM Capacity$$

$$then$$

$${PA}_{VM} = LBA + Offset$$

$$else$$

$${PA}_{NVM} = L 2 P [ LBA ]$$

where LBA is the logical block address,
NVM Capacity is he user-addressable capacity of the VM dies 140A-140N,
PA_{VM} is the physical address of a TU residing on the VM dies 140A-140N,
Offset is the optional offset to be applied to the logical addresses,
PA_{NVM} is the physical address of a TU residing on the VM dies 130A-130K,
L2P[ . . . ] is the logical-to-physical (L2P) address translation table, and
L2P[LBA] is the physical address corresponding to the specified LBA.

In an illustrative example, the total user-addressable capacity of the VM dies 140A-140N may be 40 GB, while the total user-addressable capacity of the NVM dies 130A-130K may be 128 GB.

Thus, the memory access requests initiated by the compute die 110 with respect to transfer units (TUs) (such as memory pages, blocks, etc.) referenced by logical addresses below the upper limit of the user-addressable capacity of the VM dies 140A-140N may be satisfied directly via the physical interfaces 118 and 124 accessing the VM dies 140A-140N.

Conversely, memory access requests initiated by the compute die 110 with respect to TUs referenced by the logical addresses exceeding the upper limit of the user-addressable capacity of the VM dies 140A-140N may be sent to the controller 122, which may translate these logical addresses to corresponding physical addresses of TUs residing on the NVM dies 130A-130K. The address translation may be facilitated by a logical-to-physical (L2P) table, which may be indexed by the logical addresses so that each entry of the table would store a physical address corresponding to the logical address identifying the entry:

$${PA}_{NVM} = L 2 P [ LBA ] .$$

FIG. 1B shows another example high-level component diagram of a hybrid NVM/HBM device 100B implemented in accordance with aspects of the present disclosure. As schematically illustrated by FIG. 1B, the hybrid memory device 100B may be implemented as an integrated circuit (IC) that includes a logic die 120, one or more NVM dies 130A-130K, and one or more volatile memory (VM) dies 140A-140N, all the dies being disposed on a common package substrate 150. While a single logic die 120 is shown in FIG. 1B for clarity and conciseness, in various other implementations, device 100B may include two or more logic dies 120. The stacked VM dies 140, NVM dies 130, and the logic die 120 may be interconnected by through-silicon vias (TSVs) 170A-170Z and microbumps 180A-180Y.

Disposed on the logic die 120 is the controller 122 managing the NVM dies 130 and/or the VM dies 140. In some implementations, the controller 122 may implement a common logical address space for the VM dies 140A-140N and the NVM dies 130A-130K. Accordingly, the controller 122 may perform logical-to-physical (L2P) address translation based on the common logical address space, as described in more detail herein above.

The host system (not shown in FIG. 1B) may communicate with the components disposed on the logic die 120, components disposed on the NVM dies 130A-130K, and/or components disposed on the VM dies 140A-140N via the host interface 124. In some implementations, the host interface 124 may be represented by a logical host interface (e.g., NVMe) operating over a physical host interface (e.g., PCIe, CXL, SATA Express, etc.).

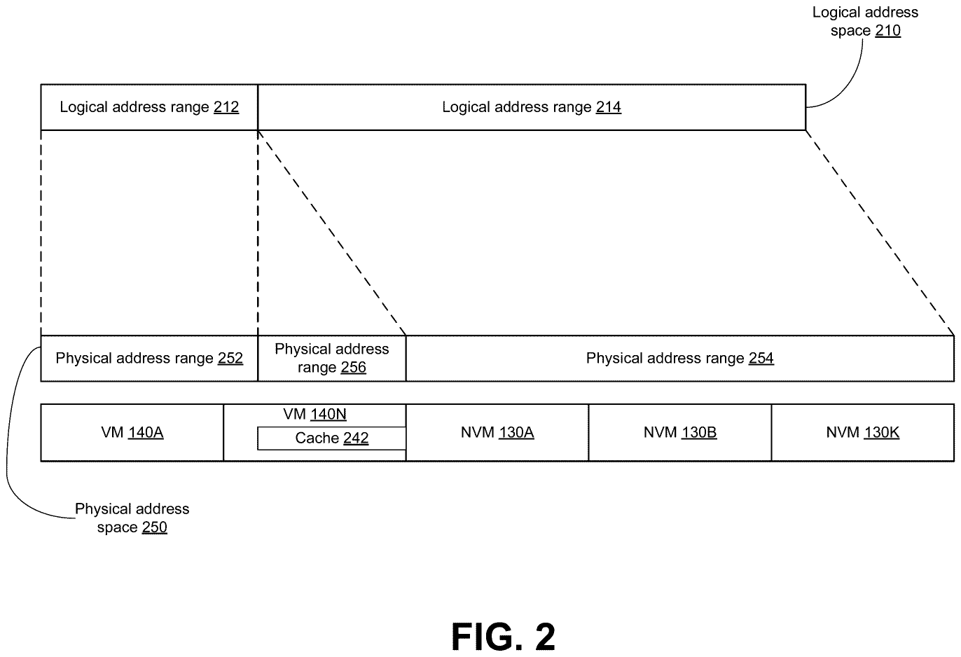

FIG. 2 schematically illustrates the example logical address space 210 and physical address space 250 of the device 100A-110B in accordance with aspects of the present disclosure. As schematically illustrated by FIG. 2, the logical address space 210 includes two logical address ranges 212 and 214.

The logical address range 212, the size of which matches the size of the user-addressable capacity of the VM dies 140A-140N, contains logical addresses that directly (e.g., with an optional offset) reference respective memory locations residing within the VM physical address range 252 corresponding to the user-addressable capacity of the VM dies 140A-140N.

The logical address range 214, residing immediately above the logical address range 212, contains logical addresses that are translatable to corresponding physical addresses identifying TUs that reside within the NVM physical address range 254 on the NVM dies 130A-130K.

In some implementations, one or more physical address sub-ranges within the physical address ranges 252 and/or 254 may be reserved by the controller 122 for performing, e.g., various memory management and/or other system tasks. Accordingly, the size of the physical address range 252 and the size of the corresponding logical address range 212 may be less than the combined capacity of the VM dies 140A-140N. Similarly, the size of the physical address range 254 and the size of the corresponding logical address range 214 may be less than the combined capacity of the NVM dies 130A-130K.

In some implementations, the content of the NVM dies 130A-130K may not be directly accessible by the processing units 112, 114. In an illustrative example, the controller 122 may reserve at least a part of the capacity of the VM dies 140A-140N for a cache 242 residing on the VM dies 140A-140N that would store certain portions (e.g., most recently accessed portions or most frequently accessed portions) of the content of the NVM dies 130A-130K. In an illustrative example, the cache 242 may reside within the reserved (i.e., user-inaccessible) physical address range 256, which may be located immediately above the VM physical address range 252 corresponding to the user-addressable capacity of the VM dies 140A-140N.

In operation, responsive to receiving a memory read request specifying a logical memory address to be read, the memory interface implemented by the logic die 120 may determine whether the logical memory address specified by the memory read request falls within the VM physical address range 252 corresponding to the user-addressable capacity of the VM dies 140A-140N.

If the logical memory address specified by the memory read request falls within the VM physical address range 252, the memory interface implemented by the logic die 120 may read, from a volatile memory die 140A-140N, the data item stored in the location identified by the logical memory address. The data item may be returned to the requestor (e.g., a processing unit 112, 114) via the memory interface (e.g., the physical interfaces 118, 124).

Conversely, if the logical memory address specified by the memory read request falls outside the VM physical address range 252, the controller 122 may translate the logical address to a corresponding physical address within the physical address range 254. The controller 122 may then read the data stored at the TU (e.g., a block or a page) referenced by the physical address and return the data to the requestor (e.g., a processing unit 112, 114) via the memory interface (e.g., the physical interfaces 118, 124).

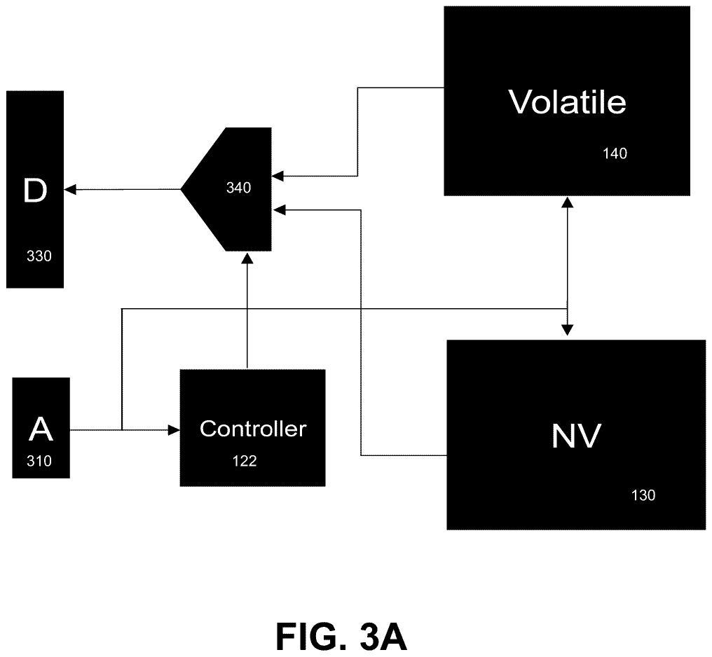

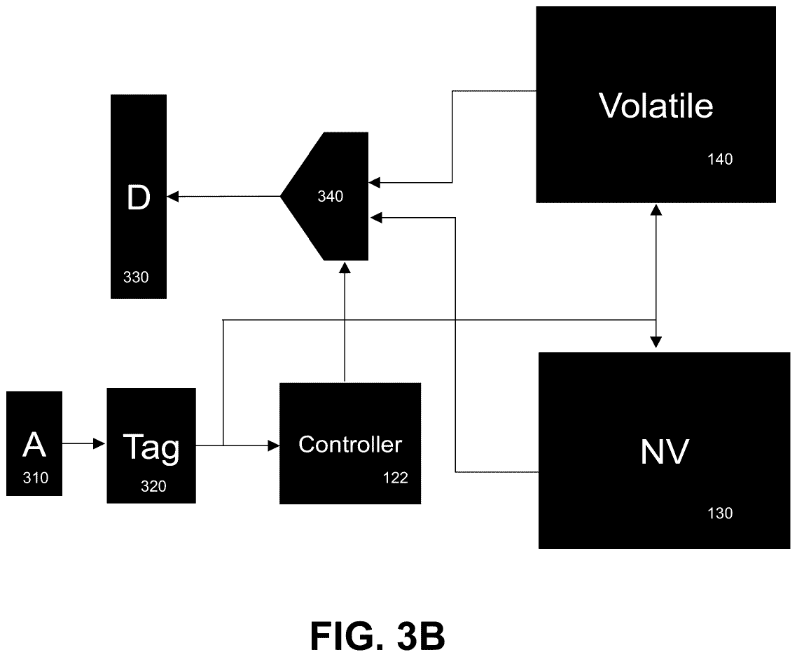

In some implementations, the controller 122 may implement the read (look aside) cache flow, as schematically illustrated by FIG. 3A. Alternatively, the controller 122 may implement the read (fully associative) look through cache flow, as schematically illustrated by FIG. 3B. In FIGS. 3A-3B, the logical address 310 specified by the read request is utilized by the controller 122 for locating, in the cache 142 residing on the volatile memory dies 140A-140N, the cache entry identified by the tag 320.

The controller 122 may determine whether the contents of the TU identified by the physical address had previously been cached by the cache 142. Should a cache hit occur, the read request may be satisfied from the cache 142. The contents of the identified cache line may be returned to the requestor (e.g., a processing unit 112, 114) via the selector 340 which selects one of the non-volatile memory 130 or volatile memory 140.

In case of a cache miss, the controller 122 may allocate a new cache entry, read the contents of the TU identified by the physical address, store the retrieved data item in the newly allocated cache entry, and return the data item 330 to the requestor processing unit 112, 114 via the selector 340 which selects one of the non-volatile memory 130 or volatile memory 140.

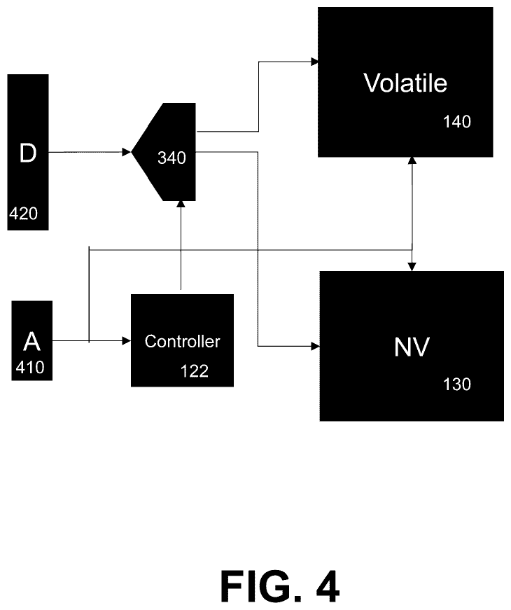

In some implementations, the cache 142 may implement the write-through policy, as schematically illustrated by FIG. 4. Accordingly, responsive to subsequently receiving a memory write request, the controller 122 may identify the cache entry whose tag matches the physical address corresponding to the logical address 410 specified by the request. The controller 122 may store (e.g., via the selector 340 which selects one of the non-volatile memory 130 or volatile memory 140) the data item 420 specified by the memory request to the identified cache entry (e.g., maintained in the volatile memory 140). The controller 122 may then store (e.g., via the selector 340 which selects one of the non-volatile memory 130 or volatile memory 140) the content of the cache entry to the TU identified by the physical address (e.g., residing in the non-volatile memory 130).

In various use cases, the IC 100 may be employed for both training and inference stages of AI models, such as large language models (LLMs), generative transformer models, etc.

In an illustrative example, the hybrid memory and compute device 100A and/or the hybrid memory device 100B may be utilized for training of an artificial intelligence (AI) model. In another illustrative example, the hybrid memory devices 100A-100B may be utilized for implementing an inference stage of an artificial intelligence (AI) model.

In an illustrative example, training an AI model involves the need of storing and frequently accessing or modifying large amounts of data, including model states, weights, parameters, etc. This need can be effectively addressed by the hybrid memory and compute device 100A and/or the hybrid memory device 100B, which significantly increase the size of the local memory co-located with one or more processing units.

In another illustrative example, performing an inference by an AI model involves handling a very large size of the model context, which requires the memory capacity that may exceed that of currently available solutions. This requirement is effectively met by the the hybrid memory and compute device 100A and/or the hybrid memory device 100B, which significantly increase the size of the local memory co-located with one or more processing units.

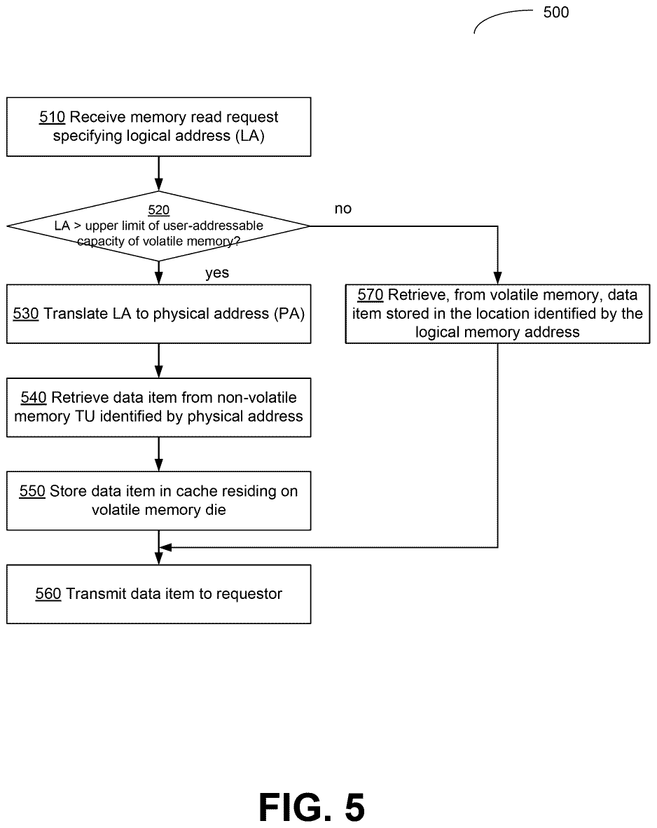

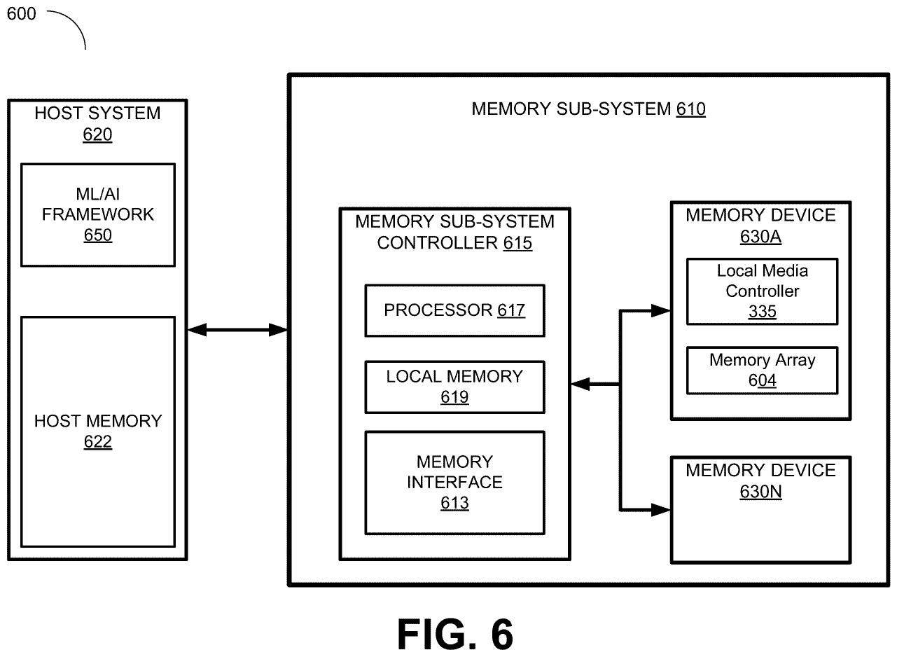

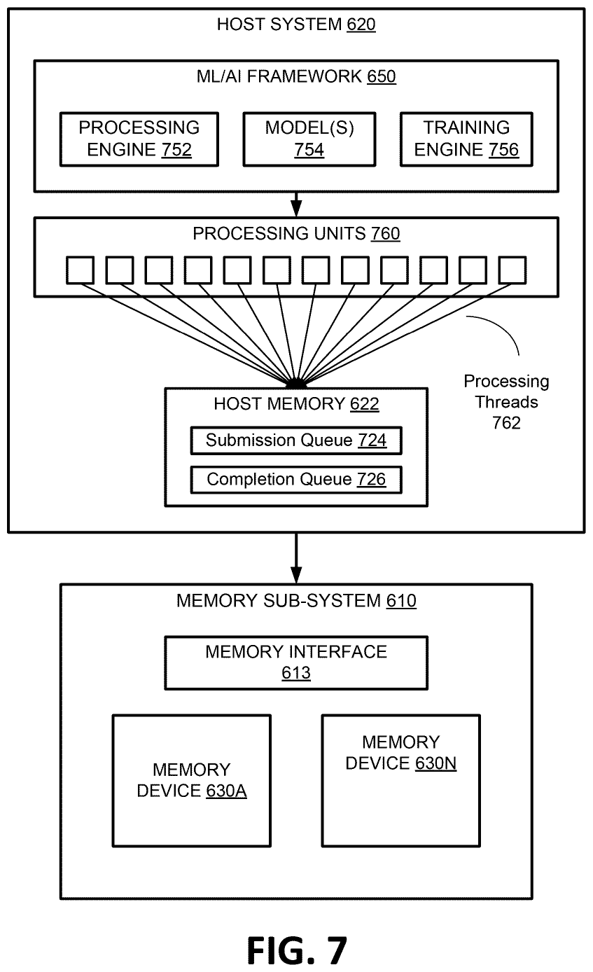

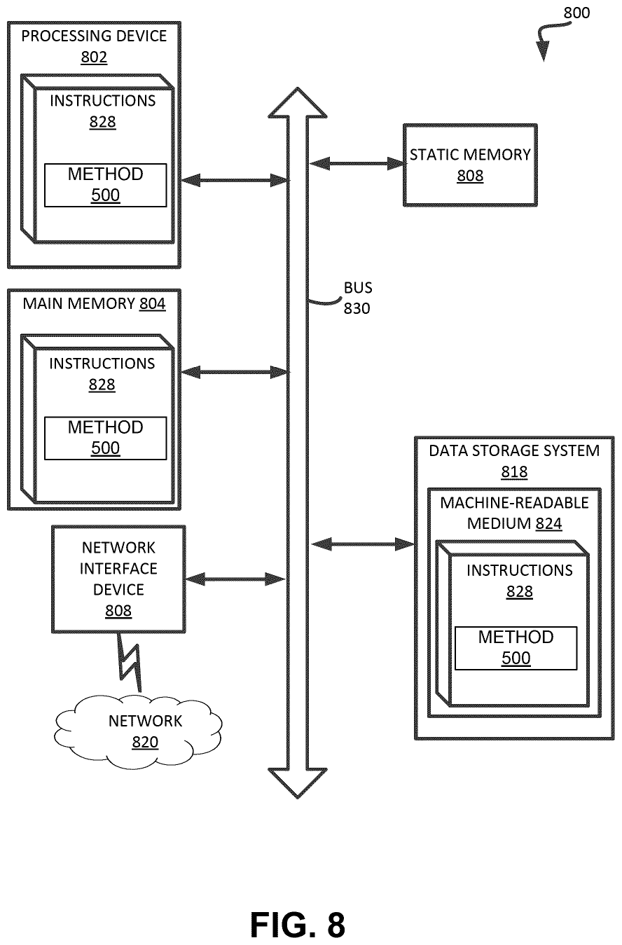

FIG. 5 is a flow diagram of an example method 500 of address translation performed by a memory controller operating in accordance with some implementations of the present disclosure. The method 500 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an illustrative example, the method 500 is performed by the controller 122 of FIGS. 1A-1B. In another illustrative example, the method 500 is performed by the memory sub-system controller 615 of FIG. 6. In another illustrative example, the method 500 is performed by the memory interface 613 of FIG. 7. In another illustrative example, the method 500 is performed by the processing device 802 of FIG. 8. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 510, the processing device implementing the method (e.g., the controller 122 managing the memory device 100A or 100B) receives a memory read request from a requestor, as described in more detail herein above.

At operation 520, the processing device determines whether the logical memory address specified by the memory read request exceeds the upper limit of the user-addressable capacity of the volatile memory dies of the memory device, as described in more detail herein above.

Responsive to determining, at operation 520, that the logical memory address exceeds the upper limit of the user-addressable capacity of the volatile memory dies of the memory device, the method continues at operation 530; conversely, responsive to determining, at operation 520, that the logical memory address is less than or equal to the upper limit of the user-addressable capacity of the volatile memory dies of the memory device, the method branches to operation 570.

At operation 530, the processing device translates the logical memory address to a corresponding physical memory address identifying a transfer unit (TU) residing on a non-volatile memory die of the memory device, as described in more detail herein above.

At operation 540, the processing device retrieves, from the non-volatile memory die, the data item stored by the TU identified by the physical memory address, as described in more detail herein above.

At operation 550, the processing device stores the data item in a cache located on a volatile memory die of the memory device, as described in more detail herein above.

At operation 560, the processing device transmits the data item to the requestor (e.g., via the memory interface implemented by PHYs 118, 124 of FIG. 1), as described in more detail herein above. Responsive to performing the operation 550, the method terminates.

At operation 570, which is performed responsive to determining, at operation 520, that the logical memory address is less than or equal to the upper limit of the user-addressable capacity of the volatile memory dies of the memory device, the processing device retrieves, from a volatile memory die of the memory device, the data item stored in the location identified by the logical memory address. In some implementations, no address translation (other than offsetting by a predefined value corresponding to the starting address of the non-volatile memory die in the logical address space of the requestor) may be required for the logical addresses that are below the upper limit of the user-addressable capacity of the VM dies 140A-140N, as described in more detail herein above. Upon performing the operation 570, the method continues at operation 560.

In some implementations, the hybrid memory and compute device 100A and/or the hybrid memory device 100B may be employed as components of a memory subsystem that is connected to a host system, as schematically illustrated by FIG. 3.

FIG. 6 illustrates a high-level component diagram of an example computing system 600 that includes a memory sub-system 610 in accordance with some implementations of the present disclosure. The memory sub-system 610 can include one or more memory devices 630A-630N, which may include one or more volatile memory devices, and/or one or more non-volatile memory devices. In an illustrative example, one or more memory devices 630 may be represented by the hybrid NVM/HBM devices 100A and/or 100B.

The memory sub-system 610 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 600 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 600 can include a host system 620 that is coupled to one or more memory sub-systems 630. In some implementations, the host system 620 is coupled to different types of memory sub-system 610. FIG. 6 illustrates one example of a host system 620 coupled to one memory sub-system 610. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 620 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 620 uses the memory sub-system 610, for example, to write data to the memory sub-system 610 and read data from the memory sub-system 610.

The host system 620 can be coupled to the memory sub-system 610 via a physical host interface. Examples of physical host interfaces include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 620 and the memory sub-system 610. The host system 620 can further utilize an NVM Express (NVMe) interface to access the memory components (e.g., the one or more memory device(s) 630) when the memory sub-system 610 is coupled with the host system 620 by the physical host interface (e.g., PCIe or CXL bus). The physical host interface can provide an interface for passing control, address, data, and other signals between the memory sub-system 610 and the host system 620. FIG. 6 illustrates a memory sub-system 610 as an example. In general, the host system 620 can access multiple memory sub-systems via a same communication connection, multiple separate communication connections, and/or a combination of communication connections.

The memory devices 630A-630N can include any combination of the different types of non-volatile memory devices and/or volatile memory devices. In an illustrative example, one or more memory devices 630 may be represented by the hybrid NVM/HBM devices 100A and/or 100B.

The volatile memory devices can be, e.g., random access memory (RAM), such as dynamic random access memory (DRAM) and synchronous dynamic random access memory (SDRAM). Some examples of non-volatile memory devices include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

A memory device 630A-630N can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some implementations, each of the memory devices 630 can include one or more arrays of memory cells such as SLCs, MLCs, TLCs, QLCs, or any combination of such. In some implementations, a particular memory device can include an SLC portion, and an MLC portion, a TLC portion, or a QLC portion of memory cells. The memory cells of the memory devices 630A-630N can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory devices 630A-630N can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory(electrically erasable programmable read-only memory (EEPROM).

A memory sub-system controller 615 can communicate with the memory device(s) 630 to perform operations such as reading data, writing data, or erasing data at the memory devices 630 and other such operations. The memory sub-system controller 615 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 615 can be a microcontroller, special purpose logic circuitry (e.g., a field programmable gate array (FPGA), an application specific integrated circuit (ASIC), etc.), or other suitable processor.

The memory sub-system controller 615 can include a processor 617 (e.g., a processing device) configured to execute instructions stored in a local memory 619. In the illustrated example, the local memory 619 of the memory sub-system controller 615 includes an embedded memory configured to store instructions for performing various processes, operations, logic flows, and routines that control operation of the memory sub-system 610, including handling communications between the memory sub-system 610 and the host system 620.

In some implementations, the local memory 619 can include memory registers storing memory pointers, fetched data, etc. The local memory 619 can also include read-only memory (ROM) for storing micro-code. While the example memory sub-system 610 in FIG. 6 has been illustrated as including the memory sub-system controller 615, in another implementation of the present disclosure, a memory sub-system 610 does not include a memory sub-system controller 615, and can instead rely upon external control (e.g., provided by an external host, or by a processor or controller separate from the memory sub-system).

In general, the memory sub-system controller 615 can receive commands or operations from the host system 620 and can convert the commands or operations into instructions or appropriate commands to achieve the desired access to the memory device(s) 630. The memory sub-system controller 615 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 630. The memory sub-system controller 615 can further include host interface circuitry to communicate with the host system 620 via the physical host interface. The host interface circuitry can convert the commands received from the host system into command instructions to access the memory device(s) 630 as well as convert responses associated with the memory device(s) 630 into information for the host system 620.

The memory sub-system 610 can also include additional circuitry or components that are not illustrated. In some implementations, the memory sub-system 610 can include a cache or buffer (e.g., DRAM) and address circuitry (e.g., a row decoder and a column decoder) that can receive an address from the memory sub-system controller 615 and decode the address to access the memory device(s) 630.

In some implementations, the memory device(s) 630 include local media controllers 365 that operate in conjunction with memory sub-system controller 615 to execute operations on one or more memory cells of the memory device(s) 630. An external controller (e.g., memory sub-system controller 615) can externally manage the memory device 630 (e.g., perform media management operations on the memory device(s) 630). In some implementations, a memory device 630 is a managed memory device, which is a raw memory device (e.g., memory array 304) having control logic (e.g., local controller 365) for media management within the same memory device package. An example of a managed memory device is a managed NAND (MNAND) device. Memory device(s) 630, for example, can each represent a single die having some control logic (e.g., local media controller 365) embodied thereon. In some implementations, the local media controller 365 may be represented by the controller 122 of FIGS. 1A-1B.

In some implementations, the memory sub-system 610 includes a memory interface 613 that is responsible for handling interactions of memory sub-system controller 615 with the memory devices of memory sub-system 610, such as memory devices 630A-630N. For example, the memory interface 613 can send memory access commands corresponding to requests received from host system 620 to memory devices 630A-630N, such as program commands, read commands, or other commands. In addition, the memory interface 613 can receive data from devices 630A-630N, such as data retrieved in response to a read command or a confirmation that a program command was successfully performed. In some implementations, the memory sub-system controller 615 includes at least a portion of the memory interface 613. For example, the memory sub-system controller 615 can include a processor 617 (processing device) configured to execute instructions stored in local memory 619 for performing the operations described herein.

In some implementations, the host system 620 implements an ML/AI framework 650. ML/AI framework 650 can include one or more ML models, a processing engine, and a training engine, among other components, which can be used to perform any automated task (e.g., classify or categorize documents or images). In order to train the one or more ML models, ML/AI framework 650 can issue requests to read the training data, which may be stored on one or more memory devices 630A-630N, and process the training data accordingly. In some implementations, ML/AI framework 650 is executed by multiple processing units (e.g., GPUs and/or CPUs) which can process many threads/streams in parallel.

In some implementations, host system 620 could include hundreds of parallel processing threads that can request and process different subsets of the training data concurrently. In some implementations, at least some of the processing tasks of the ML/AI framework 650 are performed by the processing units 112, 114 residing on the compute die 1120 of a hybrid memory device 100A of FIG. 1A; one or more hybrid memory devices 100A may be employed by the memory sub-system as memory devices 630A-630N.

Once a certain amount of training is complete, ML/AI framework 650 can enter an inference phase to analyze different input data. The input data can similarly be stored on memory device 630 of the same or a different memory sub-system 610. In some implementations, ML/AI framework 650 can issue requests to read the input data from memory sub-system 610 and store a copy of the input data in the host memory 622.

In some implementations, the host system 620 utilizes a set of queues to track the memory access commands issued to the memory sub-system 610 (e.g., requests to read data for ML/AI framework 650). For example, the host system 620 can include a number of submission queues, storing submission queue entries representing the memory access commands issued to the memory sub-system 610, and a number of completion queues, storing completion queue entries received from the memory sub-system 610 to indicate that the corresponding memory access commands have been executed. In some implementations, the host system 620 can maintain these queues in the host memory 622.

The host memory 622 may include one or more dynamic random access memory (DRAM) devices, HBM devices, and/or other types of memory devices. In some implementations, the host memory 622 may include one or more hybrid HBM/NVM memory devices 100A and/or 100B of FIGS. 1A-1B.

FIG. 7 is a block diagram illustrating a system for performing AI model inference operations using memory devices and/or host systems implemented in accordance with aspects of the present disclosure. As illustrated, host system 620 includes ML/AI framework 650 which can be executed by a number of processing threads 762. Host system 620 further includes host memory 622, including submission queues 724 and completion queues 246. In some implementations, ML/AI framework 650 includes a processing engine 752, one or more machine learning models 754, and a training engine 756, among other components, which can be used to perform any automated task (e.g., classify or categorize documents or images). Depending on the implementation one or more components that make up ML/AI framework 650 can be distributed across multiple different computing devices (e.g., host computers, servers, etc.). In some implementations, processing engine 752 may use a set of trained machine learning models 754 that are trained and used to perform any number of automated operations. The processing engine 752 may also preprocess any received input data prior to using the data for training of the set of machine learning models 754 and/or applying the set of trained machine learning models 754 to the input data. Based on the output of the set of trained machine learning models 754, the processing engine 752 may obtain, for example, a classification and/or category of the input data, as well an assessment of the classification.

In some implementations, at least some of the processing tasks of the ML/AI framework 650 are performed by the processing units 112, 114 residing on the compute die 1120 of a hybrid memory device 100A of FIG. 1A; one or more hybrid memory devices 100A may be employed by the memory sub-system as memory devices 630A-630N.

The set of machine learning models 474 may refer to model artifacts that are created by the training engine 756 using training data that includes training inputs and corresponding target outputs (i.e., correct answers for respective training inputs). During training, patterns in the training data that map the training input to the target output (i.e., the answer to be predicted) can be found, and are subsequently used by the machine learning models 754 for future predictions. Depending on the implementation, the set of machine learning models 754 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 754, ML/AI framework 650 can issue requests to read training data and input data, which may be stored on memory device 630 of memory sub-system 610, and process the data accordingly. In some implementations, these memory access requests are sent by the parallel processing threads 762 being executed by respective processing units 760. The processing units 760 can include a number of general-purpose processing devices such as microprocessors, central processing units (CPUs), or the like, or more specialized processing devices, such as graphics processing units (GPUs), which may be optimized for performing high-speed sequential processing operations. Depending on the implementation there can be any number of processing units 760 (e.g., tens or hundreds), each executing a respective one of processing threads 762. Each processing thread 762 represents a series of sequential operations directed to memory sub-system 610 (e.g., read requests for separate segments of an element of training or input data stored at memory sub-system 610). Due to the large relative size of the training data or input data, each element may be broken up into separate segments of a smaller fixed size and stored at sequential memory addresses in memory sub-system 610. Thus, in order to read the entire element of data, a sequence of multiple read requests can be issued to obtain all of the separate segments. Each processing thread 462 can include a series of read requests to read the segments of a different element of data from memory sub-system 610. Upon the read requests from each processing thread 762 being generated, the requests can be stored as entries in one of submission queues 724, from which they can be issued to memory sub-system 610. Received responses to the requests from memory sub-system 610 can be stored as entries in one of completion queues 746, retrieved by processing threads 762 and provided to ML/AI framework 650 for execution in either a training phase or an inference phase.

FIG. 8 illustrates an example machine of a computer system 800 within which a set of instructions, for causing the machine to perform any one or more of the methodologies discussed herein, can be executed. In some implementations, the computer system 800 can correspond to a host system (e.g., the host system 620 of FIG. 6) that includes, is coupled to, or utilizes a memory sub-system (e.g., the memory sub-system 610 of FIG. 6) or can be used to perform the operations of a controller (e.g., to execute an operating system to perform operations corresponding to the memory interface 613 or memory sub-system controller 618 of FIG. 6). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 808 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 828 for performing the operations and steps discussed herein (e.g., method 500 of address translation). The computer system 800 can further include a network interface device 808 to communicate over the network 820.

The data storage system 818 can include a machine-readable storage medium 824 (also known as a computer-readable medium) on which is stored one or more sets of instructions 828 or software embodying any one or more of the methodologies or functions described herein. The instructions 828 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1. In some implementations, the data storage system 818 may include one or more hybrid HBM/NVM memory devices 100A and/or 100B of FIGS. 1A-1B.

In some implementations, the instructions 828 include instructions to implement functionality corresponding to the controller 122 of FIGS. 1A-1B (e.g., implementing method 500 of address translation). In some implementations, the instructions 828 include instructions to implement functionality corresponding to the controller 615 of FIG. 6 (e.g., implementing method 500 of address translation). In some implementations, the instructions 828 include instructions to implement functionality corresponding to the memory interface 613 of FIG. 7 (e.g., implementing method 500 of address translation). While the machine-readable storage medium 824 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method, comprising:
receiving, by a memory controller of a memory device comprising one or more volatile memory dies and one or more non-volatile memory dies, a memory read request from a requestor;
determining whether a logical memory address specified by the memory read request exceeds an upper limit of a user-addressable capacity of the one or more volatile memory dies;
responsive to determining that the logical memory address exceeds the upper limit of the user-addressable capacity of the one or more volatile memory dies, translating the logical memory address to a physical memory address identifying a transfer unit (TU) residing on a non-volatile memory die of one or more non-volatile memory dies;
retrieving, from the non-volatile memory die, a data item stored by the TU identified by the physical memory address;
storing the data item in a cache located on a volatile memory die of the one or more volatile memory dies; and
transmitting the data item to the requestor.

2. The method of claim 1, wherein the one or more volatile memory dies comprise one or more high-bandwidth dynamic random access memory (DRAM) dies.

3. The method of claim 1, wherein the non-volatile memory die is represented by a negative-AND (NAND) die.

4. The method of claim 1, further comprising:
receiving a memory write request specifying a second data item and the logical memory address;
storing the second data item to the cache located on the volatile memory die; and
storing the second data item to the transfer unit (TU) residing on the non-volatile memory die.

5. The method of claim 1, further comprising:
responsive to determining that the logical memory address does not exceed the upper limit of the user-addressable capacity of the one or more volatile memory dies, retrieving, from a volatile memory die of the one or more volatile memory dies, a second data item stored in a location identified by the logical memory address; and
transmitting the second data item, via the volatile memory interface, to the requestor.

6. The method of claim 1, wherein the memory device is represented by an integrated circuit further comprising a compute die comprising at least one of: a graphic processing unit (GPU) or a central processing unit (CPU).

7. The method of claim 1, wherein the memory device is represented by an integrated circuit further comprising one or more processing units utilized for at least one of: training an artificial intelligence (AI) model or implementing an inference stage of an artificial intelligence (AI) model.

8. A computer-readable non-transitory storage medium comprising executable instructions that, when executed by a memory controller of a memory device comprising one or more volatile memory dies and one or more non-volatile memory dies, cause the memory controller to perform operations comprising:
receiving a memory read request from a requestor;
determining whether a logical memory address specified by the memory read request exceeds an upper limit of a user-addressable capacity of the one or more volatile memory dies;
responsive to determining that the logical memory address exceeds the upper limit of the user-addressable capacity of the one or more volatile memory dies, translating the logical memory address to a physical memory address identifying a transfer unit (TU) residing on a non-volatile memory die of one or more non-volatile memory dies;
retrieving, from the non-volatile memory die, a data item stored by the TU identified by the physical memory address;
storing the data item in a cache located on a volatile memory die of the one or more volatile memory dies; and
transmitting the data item to the requestor.

9. The computer-readable non-transitory storage medium of claim 8, wherein the one or more volatile memory dies comprise one or more high-bandwidth dynamic random access memory (DRAM) dies.

10. The computer-readable non-transitory storage medium of claim 8, wherein the non-volatile memory die is represented by a negative-AND (NAND) die.

11. The computer-readable non-transitory storage medium of claim 8, wherein the operations further comprise:
receiving a memory write request specifying a second data item and the logical memory address;
storing the second data item to the cache located on the volatile memory die; and
storing the second data item to the transfer unit (TU) residing on the non-volatile memory die.

12. The computer-readable non-transitory storage medium of claim 8, wherein the operations further comprise:
responsive to determining that the logical memory address does not exceed the upper limit of the user-addressable capacity of the one or more volatile memory dies, retrieving, from a volatile memory die of the one or more volatile memory dies, a second data item stored in a location identified by the logical memory address; and
transmitting the second data item, via the volatile memory interface, to the requestor.

13. The computer-readable non-transitory storage medium of claim 8, wherein the memory device is represented by an integrated circuit further comprising a compute die comprising at least one of: a graphic processing unit (GPU) or a central processing unit (CPU).

14. The computer-readable non-transitory storage medium of claim 8, wherein the memory device is represented by an integrated circuit further comprising one or more processing units utilized for at least one of: training an artificial intelligence (AI) model or implementing an inference stage of an artificial intelligence (AI) model.

15. A device, comprising:
one or more volatile memory dies;
one or more non-volatile memory dies;
a compute die comprising one or more processing units;
a logic die comprising a memory controller; and
an interposer interconnecting the compute die and the logic die;
wherein the memory controller is configured to perform operations, comprising:
receiving, from a processing unit of the one or more processing units, a memory read request specifying a logical memory address;
determining whether the logical memory address exceeds an upper limit of a user-addressable capacity of the one or more volatile memory dies;
responsive to determining that the logical memory address exceeds the upper limit of the user-addressable capacity of the one or more volatile memory dies, translating the logical memory address to a physical memory address identifying a transfer unit (TU) residing on a non-volatile memory die of the one or more non-volatile memory dies;
retrieving, from the non-volatile memory die, a data item stored by the TU identified by the physical memory address;
storing the data item in a cache located on a volatile memory die of the one or more volatile memory dies; and
transmitting the data item, via a volatile memory interface implemented by the interposer, to the processing unit.

16. The device of claim 15, wherein the logic die, the one or more volatile memory dies, the one or more non-volatile memory dies, the compute die, and the interposer are disposed on a common package substrate.

17. The device of claim 15, wherein the one or more processing units comprise at least one of: a graphic processing unit (GPU) or a central processing unit (CPU).

18. The device of claim 1, wherein the one or more volatile memory dies comprise one or more high-bandwidth dynamic random access memory (DRAM) dies.

19. The device of claim 1, wherein the one or more non-volatile memory dies comprise one or more negative-AND (NAND) dies.

20. The device of claim 1, wherein the one or more processing units utilized for at least one of: training an artificial intelligence (AI) model or implementing an inference stage of an artificial intelligence (AI) model.
